(19) United States
(12) Patent Application Publication
(10) Pub. No.: US 2012/0268852 A1
(43) Pub. Date: Oct. 25, 2012

(54) SYSTEMS AND METHODS FOR TESTABLE CURRENT LIMITING WITH HICCUP RESET

(75) Inventor: Stephen Rogoff, Glendale, AZ (US)

(73) Assignee: HONEYWELL INTERNATIONAL INC., Morristown, NJ (US)

(21) Appl. No.: 13/093,280

(22) Filed: Apr. 25, 2011

(51) Int. Cl. H02H 3/06

(52) U.S. Cl. 361/93.4

(57) ABSTRACT

Testable current limiting with hiccup reset is provided. In one embodiment, a current limiter comprises: a current regulating circuit having a pass-transistor wherein a load current delivered to a load side flows through the pass-transistor, the current regulating circuit clamps the load current when the load current exceeds a threshold; a latch regulating circuit coupled to the current regulating circuit, and further coupled to a line side through a semiconductor having a turn-on voltage threshold higher than the pass-transistor; and a current limit test circuit configured to apply a reference impedance to the load side output. The latch regulating circuit compares a voltage from the current regulating circuit to a voltage measured at the semiconductor to determine when the load current exceeds the threshold. When the load current exceeds the threshold for a period of time exceeding a predetermined duration, the latch regulating circuit temporarily shuts off the pass-transistor.

### BACKGROUND

A typical design for a smoke detector circuit for a commercial aircraft will include up to forty-four smoke detectors, each having their own individual power supply units, all fed from a single circuit breaker. The power supply units typically have the ability to self limit the amount of current they source to their connected loads. This means that if a device connected to the power supply experiences a fault, the power supply unit that feeds that device can limit the current feeding the fault. However, when a power supply unit itself fails internally, its ability to limit fault current is compromised. Thus, if a power supply unit for any one of these forty-four units experiences a fault during flight, the excessive current condition will cause the circuit breaker feeding the fault to trip, cutting off power for the entire smoke detector circuit. All devices and systems powered from that circuit breaker will remain unusable for the duration of the flight.

For the reasons stated above and for other reasons stated below which will become apparent to those skilled in the art upon reading and understanding the specification, there is a need in the art for improved systems and methods for testable current limiting with hiccup reset.

### SUMMARY

The Embodiments of the present invention provide methods and systems for testable current limiting with hiccup reset and will be understood by reading and studying the following specification.

In one embodiment, a current limiter apparatus having a line side input and a load side output comprises: a current regulating circuit having a pass transistor that couples the line side input to the load side output, wherein a load current delivered to the load side output flows through the pass transistor, and wherein the current regulating circuit is configured to clamp the load current to a predefined current limit when the load current exceeds a current limiting threshold; a latch regulating circuit coupled to the current regulating circuit, the latch regulating circuit further coupled to the line side input through a semiconductor device having a turn-on voltage threshold higher than the pass transistor; wherein the latch regulating circuit compares a first voltage received from the current regulating circuit to a second voltage measured at the semiconductor device to determine when the load current exceeds the current limiting threshold and wherein when the load current exceeds the current limiting threshold for a period of time exceeding a predetermined current limiting duration, the latch regulating circuit temporarily shuts off the pass transistor for a predetermined latching period; and a current limit test circuit coupled to the load side output, the current limit test circuit including a reference impedance and a switching device, wherein the switching device is configured to apply the reference impedance to the load side output.

### DRAWINGS

Embodiments of the present invention can be more easily understood and further advantages and uses thereof more readily apparent, when considered in view of the description of the preferred embodiments and the following figures in which:

FIG. 1 is a block diagram of a current limiter apparatus of one embodiment of the present invention;

FIG. 2 is a schematic diagram of a current limiter apparatus of one embodiment of the present invention; and

FIG. 3 is a flow chart illustrating a method of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention provide a current limiter device, for example in the form of a front end device which is coupled to the line side of a power supply. By limiting the amount of current a faulted power supply can draw to an amount below the trip setting of an upstream circuit breaker, the current limiter device can prevent a faulted power supply from causing that breaker to trip. In some embodiments of the present invention, the current limiter device further provides a testable current limiter that can determine whether the current limiting function of the current limiter is functioning properly. That is, it can test whether the current limiter device is in fact capable of limiting current to its downstream load. Further, momentary over current events initiate the current limiting function of the current limiter device without causing the device to permanently latch in the off state.

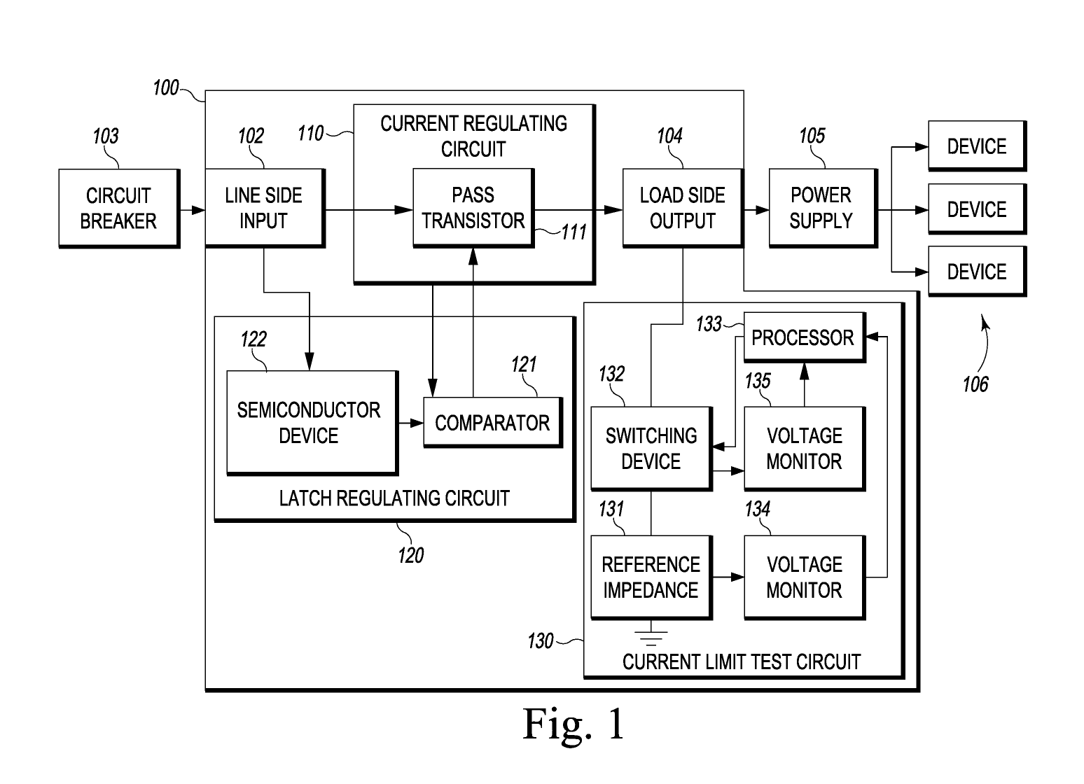

FIG. 1 is a simplified block diagram illustrating a current limiter apparatus 100 of one embodiment of the present invention. In the embodiment shown in FIG. 1, current limiter apparatus 100 functions as a front end current limiter between a power distribution circuit coupled to a line side input 102 and a power supply 105 coupled to load side output 104. Line side input 102 is supplied electrical power via circuit breaker 103. In one embodiment, load side output 104 feed power supply 105 (such as a 24VDC power supply) which in turn provides current to one or more devices 106.

Current limiter apparatus 100 comprises a current regulating circuit 110, a latch regulating circuit 120 and a current limit test circuit 130. By clamping the amount of current that can pass through current regulating circuit 110, current limiter apparatus 100 prevents failures of power supply 105 from drawing sufficient current to trip the line side circuit breaker 103. Current regulating circuit 110 further comprises pass transistor 112 through which all current supplied by breaker 103 to power supply 105 passes. Heat is generated at pass transistor 112 as a function of its own internal resistance times current squared. As such, pass transistor 112 will heat up and will fail if called upon to indefinitely supply a current at a clamped level that exceeds its power rating. To avoid the need to use transistors capable of withstanding high currents (which are typically expensive relative to transistors with standard power ratings), latch regulating circuit 120 will cause pass transistor 112 to turn off after a predetermined time period referred to herein as the “current limiting duration.” That is, the current limiting duration is period of time for which pass transistor 112 can supply current at the clamped current level without burning up pass transistor 112.

In operation, as long as the current draw of from load side output 104 is below the current limiting threshold, pass transistor 112 will supply that current indefinitely. Should the current draw at the load side output 104 exceed the current limiting threshold, current regulating circuit 110 will supply current at a clamped current limit for the current limiting duration. Once the current limiting duration times out, latch regulating circuit 120 will set a temporary latch that will completely turn off pass transistor 112, and thus power to the load 104, for a predefined latch period duration.

As would be appreciated by those of ordinary skill in the art upon reading this specification, voltage levels of power distribution networks will typically vary over time from their nominal values. This is especially the case in applications such as onboard vehicles. For example, a nominally rated 24V circuit on an aircraft can operate anywhere between 16-32 volts. Latch regulating circuit 120 address this variability in two ways. First, latch regulating circuit 120 includes a comparator 121 that monitors the voltage, V1, actually being supplied by breaker 103 and compares it against a voltage controlling current through pass transistor 112 so that even as the line voltage varies, the current limiter apparatus will operate consistently. Second, the line voltage is monitored by comparator 121 through a semiconductor device 122 (such as a zener diode, for example) that is selected to have turn-on threshold that is higher than the turn-on threshold voltage of pass transistor 112. Thus, comparator 121 can accurately monitor when the pass transistor 112 is operating in saturation versus when the transistor is in the linear mode to limit the current in spite of variations in line voltages.

After the latch period duration expires, latch regulating circuit 120 will release its latch on pass transistor 112, allowing current to again flow through load side output 104. If the restored current drawn remains below the current limiting threshold, current regulating circuit 110 will permit that current to flow to the load. If the current demand remains excessive after power is restored (indicating that a downstream fault condition still exists) current regulating circuit 110 will clamp the current and latch regulating circuit 120 will again cause pass transistor 112 to cut off power in time to prevent tripping of the upstream circuit breaker and prevent damage to pass transistor 112. The current limiter apparatus 100 will repeat this limit-latch-retry-cycle as long as the downstream fault condition remains, assuming that current limiter apparatus 100 is itself still receiving power from breaker 103.

Although the term “fault” is generally used herein to described an excess current draw from load output side 104, the term is intended to include both events causing sudden step changes in current (i.e., instantaneous over current events) or degradations that cause current to ramp up over time (i.e., time over current events such as steadily increasing overload conditions). For example, if current demand from power supply 105 ramps up over time but remains below the current limit threshold, the current regulating circuit 110 will not respond. Should it begin to exceed the current limit threshold, current will be clamped for the predetermined current limiting duration before the temporary latch is again set by latch regulating circuit 120.

Current limit test circuit 130 provides the ability to verify whether the current limiting function of device 100 is operable by quickly applying a known low reference impedance 131 (i.e., a short circuit) to the output of current regulating circuit 110, measuring the voltage produced across impedance 131, and then quickly removing the short circuit before the current limiting duration expires. When current regulating circuit 110 is operating correctly, current flowing through the reference impedance 131 will be clamped at the current limit. This will produce a predictable voltage (that is, within the range of an acceptance criteria) across impedance 131. If the voltage measured is much higher, then the current limiter 100 is not limiting current. During the test, the limit-latch-retry-cycle will begin. However, because the test duration (e.g., 1 ms) is less than the current limiting duration (e.g., 10 ms), sufficient time will not elapse to allow the current limiting function to set the temporary latch. For applications where the load side power supply can ride out the 1 ms power loss, such testing can be either automatically or manually performed while the circuit 100 is in service.

In one embodiment, applying impedance 131 to the load side output 104 is controlled by a switching device 132. In one embodiment, switching device 132 comprises a transistor that is switched on to apply impedance 131 to the load side output 104. In another embodiment, switching device 132 comprises a set of contacts that open and close. Further, in one embodiment a processor 133 (which may or may not be an integrated part of limiter 100) controls the operation of switching device 132. In one embodiment, a voltage sensor 134, such as a high-speed analog to digital converter, reads the voltage across the impedance 131 and provides the resulting data to the processor 133 for comparison against an expected voltage value. In some implementations, the processor 133 itself is equipped with an internal high-speed analog to digital converter so that the analog voltage signal can be directly processed by the processor 133. In one embodiment, a second voltage sensor 135 (also coupled to processor 133) may be optionally utilized to measure and verify the test signal applied to activate switching device 132. This allows processor 133 to determine whether a failure to read an expected voltage across impedance 131 is due to a problem with current regulating circuit 110 or with switching device 132. For example, in one embodiment in operation, processor 133 sets a discrete output for 4 volts to activate switching device 132 and waits 1 ms to take measurement across test impedance 131. Further, the voltage of the test initiating signal applied to switching device 132 by processor 133 is also be measured in order to verify that a valid test was in fact performed.

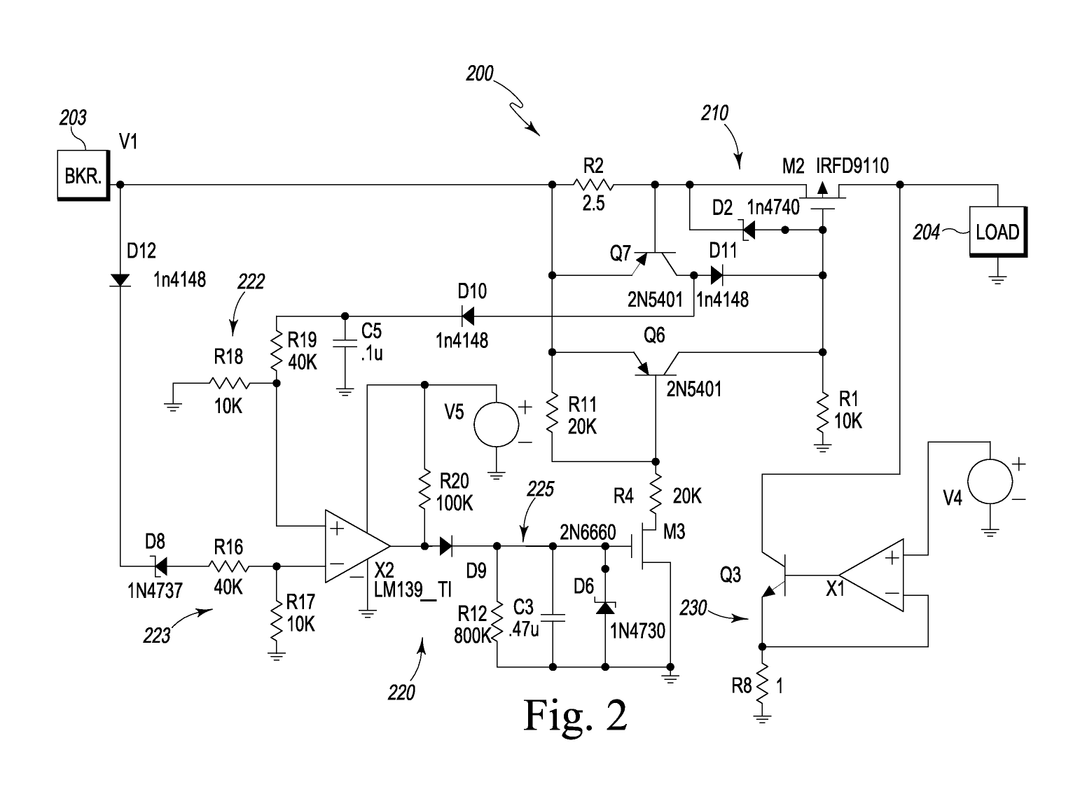

FIG. 2 is a schematic diagram illustrating a current limiter apparatus 200 of one embodiment of the present invention. Current limiter apparatus 200 includes each of the three components of a current regulating circuit 210, a latch regulating circuit 220 and a current limit test circuit 230 such as described above for FIG. 1.

As discussed above, current regulating circuit 210 comprises resistor R2 coupled to the source gate of a pass transistor M2. In FIG. 2, pass transistor M2 is shown as a PNP NMOS transistor. However, other embodiments, other transistors may be used. All current supplied to load 204 will pass through R2 and the source gate of pass transistor M2. As the current through R2 increases, the voltage across R2 also increases proportionally. R2 is in parallel with transistor Q7 such that when the current through R2 reaches a threshold, transistor Q7 will become forward-biased. Depending on the current M2 is supplying to the connected loads, Q7 will eventually turn on as a function of the voltage across R2. When Q7 turns on, the source-gate voltage across M2 is regulated by the base and collector currents of Q7, thus limiting the current that can flow through M2 to the load. That is, as increased current demand by M2 causes Q7's base current to increase, the collector current from Q7 will vary accordingly, causing M2 to clamp the amount of current it will supply.

Current passed by M2 to the load 204 will clamp to an amperage value that is a function of the resistance value of R2 in ohms. That is, the value of R2 in ohms times the current through R2 determines the voltage across R2. When that voltage causes approximately a 0.7V voltage drop (Q7's emitter-base threshold voltage) across the emitter -base junction of Q7, Q7 will turn on enough to raise the voltage at the gate of M2 so that the current is limited through M2 and the voltage across R2 remains constant (where the constant voltage is equal to the limited current times the resistance).

As shown in FIG. 2, the collector of Q7 is coupled to the gate of M2 to control the voltage across the source-gate junction of M2. This same voltage is applied to diode D10 of latch regulating circuit 220. Thus, the voltage regulating M2 is one of the voltages monitored by latch regulating circuit 220. The second voltage monitored is the line voltage V1 supplied by breaker 203 as monitored through zener diode D8. Both the first and second voltages are proportionally reduced by the respective voltage dividing networks 222 and 223.

Normally, when an over current condition does not exist, the input to the comparator X2 from Q7 is 0 VDC. When the over current condition occurs and Q7 is controlling the gate voltage to M2 so that the current is limited, the voltage to the comparator X2 from Q7 is essentially equal to M2′s gate voltage. In order to limit the current through M2, the gate voltage has to increase closer to the input voltage than when the transistor is driven into saturation. Because the gate voltage has to go higher to limit the current, the voltage to the comparator X2 from Q7 now is above the voltage set by the zener diode D8. The comparator X2 will now change state.

Once the difference in voltage between the two inputs of comparator X2 reaches a threshold point, comparator X2 changes state from a grounded output to an open output (i.e., the comparator is an open collector device and only sinks current to ground). When comparator X2 transitions to the open state, the input voltage to the gate voltage of NMOS transistor M3 begins to increase as C3 charges through R20. The RC timing circuit 225 includes resistance R20, R12 and capacitance C3 elements to arrive at a desired time constant, which in part determines the current limiting duration, as well as the latch period duration.

Comparator X2 is either on (open output) or off (grounded output). The voltage dividers provided by resistors R16, R17 and R18, R19 function to drop the voltage levels applied to comparator X2 down to within its designed operating range as defined by the device manufacturer's specifications. Zener diode D8 is the semiconductor device discussed above that is selected to have a voltage drop higher that the turn-on threshold voltage of pass transistor M2. When the source-gate voltage across M2 becomes less than the turn-off voltage, M2 will shut off

Relatively speaking, M3 will turn on quickly but not turn off quickly. M3 has a controlled turn on time based on the time constant of R20 and C3. This time is the delay time for the first over current condition that is provided to allow the circuit to be tested. With M3 turned on, the base-emitter junction of Q6 will become forward-biased, turning Q6 on hard, which in turn will bring the line voltage (V1) directly to the gate of M2. This will immediately turn off M2 and the current to load 204. At this point, Q6 is preventing any pass current from reaching the load because it is holding the source-gate voltage at M2 to zero.

With the pass current at zero, the voltage produced across R2 is also zero so that transistor Q7 turns off, shutting down the current limiting function. Further, with Q7 turned off, current through diode D10 drops, the voltage across capacitor C5 begins to drop, and thus the first voltage input to comparator X2 will decay rapidly. As would be appreciated by one of ordinary skill in the art, the larger the capacitance of C5, the longer it will take for the input voltage at X2 to decay to the point that will cause X2 to turn off. Thus the duration of the latch period of the limit-latch-reset-cycle is at least partly a function of the capacitance value of C5. Once X2 turns off, transistor M3 will remain on until capacitor C3 sufficiently discharges through R12. Thus the duration of the latch period of the reset-retry-cycle is also at least partly a function of the values of C5 and R12. Once C3 discharges below M3's turn on voltage, M3 will turn off, which in turn will turn off Q6. With its source-gate voltage no longer being held to zero, M2 will snap on to restore the delivery of current to load 104. In one embodiment, the zener diode D2 is provided across the source-gate junction of M2 limit the maximum possible voltage across the source-gate junction of M2.

When the pass transistor M2 turns back on, voltage across R2 is again produced proportional to the pass current. If that voltage is sufficient to turn Q7 back on, then current limiting will again initiate until Q6 turns M2 back off. During this second cycle however, the current limiting period will be shorter because C3 will still be partially charged so that M3 will respond much faster to turn Q6 on. By shutting down pass transistor M2, operation of Q6 thus functions to keep M2 from overheating due to supplying the pass current at the current limited level.

Current limit test circuit 230 includes a reference impedance R8 and a switching device 232 comprising a transistor Q3 operated by amplifier X1. Amplifier X1 is driven by a voltage V4 which may be controlled by a processor, such as described in FIG. 1 above, so that a very quick (1 ms) voltage measurement is obtained to apply reference impedance to the output of limiter 200. When a voltage measured across impedance R8 is the value expected, then the current regulating circuit 210 is operating correctly. If the voltage measured is much higher or much lower than expected (that is, outside of an acceptance criteria), then the current regulating circuit 210 is not limiting current as expected.

Referring back to FIG. 1, in one embodiment, the voltage monitor 134 would measure voltage across R8 while voltage monitor 135 would measure the voltage applied to amplifier X1. Processor 133 would drive one of its outputs to 3.3 volts as a test initiating signal that turns on amplifier X1.

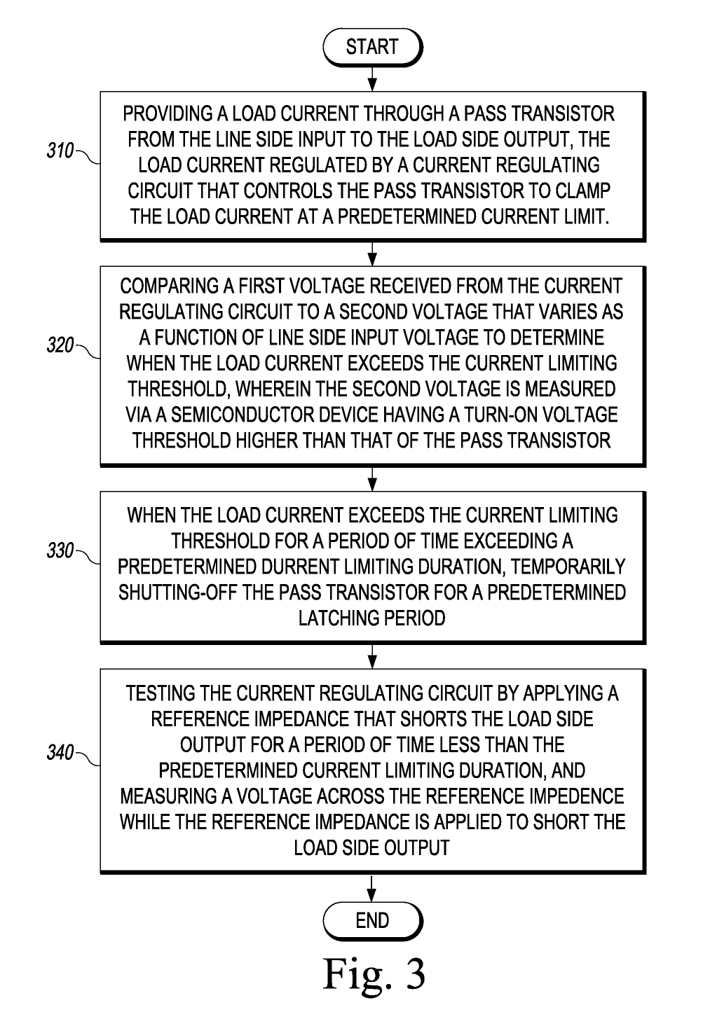

FIG. 3 is a flow chart illustrating a method of one embodiment of the present invention. In one embodiment, the method of FIG. 3 is implemented using the apparatus disclosed in FIG. 1. In another embodiment, the method of FIG. 3 is implemented using the apparatus disclosed in FIG. 2. As such descriptions provided below with respect to FIG. 3 apply to the descriptions of FIGS. 1 and 2 and vice versa. As such, one implementation of the method shown in FIG. 3 provides a method for current limiting, which may be performed by a front end device which is coupled to the line side of a power supply. By limiting the amount of current a faulted power supply can draw to an amount below the trip setting of an upstream circuit breaker, the method can prevent a faulted power supply from causing that breaker to trip. In some implementations, the method further provides for a testable current limiter that can determine whether the current limiting function of the current limiter is functioning properly. That is, it can test whether the current limiter device is in fact capable of limiting current to its downstream load.

The method begins at 310 with providing a load current through a pass transistor from the line side input to the load side output, the load current regulated by a current regulating circuit that controls the pass transistor to clamp the load current at a predetermined current limit. In one embodiment, when the load current exceeds the current limiting threshold, regulating a voltage across the pass transistor to clamp the load current to the predefined current limit. In one embodiment, the current regulating circuit comprises a first transistor coupled across a junction of the pass transistor, wherein the first transistor is configured to limit the load current to the predetermined current limit. The first transistor includes a base terminal coupled to a source terminal of the pass transistor and a collector terminal coupled to a gate terminal of the pass transistor. In operation, as long as the current draw of from load side output is below the current limiting threshold, the load current may be supplied indefinitely. When the current draw exceeds the current limiting threshold, the current regulating circuit clamps the load current to the predetermined current limit for the current limiting duration. When the current draw exceeds the current limiting threshold, the current regulating circuit clamps the load current to the predetermined current limit for a current limiting duration, as discussed further below.

The method proceeds to 320 with comparing a first voltage received from the current regulating circuit to a second voltage that varies as a function of line side input voltage to determine when the load current exceeds the current limiting threshold, wherein the second voltage is measured via a semiconductor device having a turn-on voltage threshold higher than that of the pass transistor. In one embodiment, the first voltage received from the current regulating circuit is produced by the first transistor.

The method proceeds to 330 with when the load current exceeds the current limiting threshold for a period of time exceeding a predetermined current limiting duration, temporarily shutting-off the pass transistor for a predetermined latching period. In one embodiment, temporarily shutting-off the pass transistor for a predetermined latching period comprises applying a voltage to a terminal of the pass transistor that shuts off the load current.

In one embodiment, the method may optionally process to 340 with testing the current regulating circuit by applying a reference impedance that shorts the load side output for a period of time less than the predetermined current limiting duration, and measuring a voltage across the reference impedance while the reference impedance is applied to short the load side output. In one embodiment, testing is initiated by receiving a test signal. Then, when the test signal is received, the method at 340 applies the reference impedance to short the load side output. It can be determined that the regulating circuit is functioning correctly when the voltage measured across the reference impedance falls within a predetermined acceptance criteria. Block 340 thus provides the ability to verify whether the current limiting function of device 100 or 200 is operable by quickly applying a known low reference impedance (i.e., a short circuit) to the output of the current regulating circuit, measuring the voltage produced across impedance, and then quickly removing the short circuit before the current limiting duration expires. When the current regulating circuit is operating correctly, current flowing through the reference impedance will be clamped at the current limit. This will produce a predictable voltage (that is, within the range of an acceptance criteria) across the impedance. If the voltage measured is outside of the acceptance criteria (i.e., much larger than expected), then the current limiter is not limiting current properly. During the testing, the limit-latch-retry-cycle will begin. However, because the test duration (e.g. 1 ms) is less than the current limiting duration (e.g. 10 ms), sufficient time will not elapse to allow the current limiting function to set the temporary latch. For applications where the load side power supply can ride out the 1 ms power loss, such testing can be either automatically or manually performed while the circuit is in service. In one embodiment, testing the current regulating circuit is initiated and performed by a processor as described above with respect to FIGS. 1 and 2.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A current limiter apparatus having a line side input and a load side output, the apparatus comprising:
a current regulating circuit having a pass transistor that couples the line side input to the load side output, wherein a load current delivered to the load side output flows through the pass transistor, and wherein the current regulating circuit is configured to clamp the load current to a predefined current limit when the load current exceeds a current limiting threshold;
a latch regulating circuit coupled to the current regulating circuit, the latch regulating circuit further coupled to the line side input through a semiconductor device having a turn-on voltage threshold higher than the pass transistor;
wherein the latch regulating circuit compares a first voltage received from the current regulating circuit to a second voltage measured at the semiconductor device to determine when the load current exceeds the current limiting threshold;
wherein when the load current exceeds the current limiting threshold for a period of time exceeding a predetermined current limiting duration, the latch regulating circuit temporarily shuts off the pass transistor for a predetermined latching period; and
a current limit test circuit coupled to the load side output, the current limit test circuit including a reference impedance and a switching device, wherein the switching device is configured to apply the reference impedance to the load side output.

2. The apparatus of claim 1, wherein the current regulating circuit further comprising a first transistor coupled across a junction of the pass transistor, wherein the first transistor is configured to limit the load current to a current limit value.

3. The apparatus of claim 2, the first transistor having a base terminal coupled to a source terminal of the pass transistor and a collector terminal coupled to a gate terminal of the pass transistor.

4. The apparatus of claim 1, the latch regulating circuit further comprising a comparator measuring a difference between the first voltage and the second voltage, wherein based on the difference between the first voltage and the second voltage the comparator causes a voltage to be applied to the pass transistor that shuts off the load current.

5. The apparatus of claim 4, the latch regulating circuit further comprising a first transistor controlled by the comparator, and a second transistor having a base terminal controlled by the first transistor, wherein the second transistor applies a voltage from the line side input to shut off the pass transistor.

6. The apparatus of claim 1, wherein the switching device is coupled to receive a test initiation signal, wherein the switching device applies the reference impedance to the load side output when the test initiation signal is received.

7. The apparatus of claim 1, wherein the switching device applies the reference impedance to the load side output for a period of time less than the predetermined current limiting duration.

8. The apparatus of claim 1, further comprising a processor coupled to the reference impedance via an analog-to-digital converter and further coupled to the switching device, wherein the processor determines whether the current regulating circuit is functional based on a voltage measured across the reference impedance when the reference impedance is applied to the load side output.

9. A method for providing limiting using a current limiter apparatus having a line side input and a load side output, the method comprising:
providing a load current through a pass transistor from the line side input to the load side output, the load current regulated by a current regulating circuit that controls the pass transistor to clamp the load current at a predetermined current limit;
comparing a first voltage received from the current regulating circuit to a second voltage that varies as a function of line side input voltage to determine when the load current exceeds the current limiting threshold, wherein the second voltage is measured via a semiconductor device having a turn-on voltage threshold higher than that of the pass transistor;
when the load current exceeds the current limiting threshold for a period of time exceeding a predetermined current limiting duration, temporarily shutting-off the pass transistor for a predetermined latching period.

10. The method of claim 9, further comprising:
when the load current exceeds the current limiting threshold, regulating a voltage across the pass transistor to clamp the load current to the predefined current limit.

11. The method of claim 9, the current regulating circuit comprising a first transistor coupled across a junction of the pass transistor, wherein the first transistor is configured to limit the load current to the predetermined current limit.

12. The method of claim 11, wherein the first transistor includes a base terminal coupled to a source terminal of the pass transistor and a collector terminal coupled to a gate terminal of the pass transistor.

13. The method of claim 11, wherein the first voltage received from the current regulating circuit is produced by the first transistor.

14. The method of claim 9, wherein temporarily shutting-off the pass transistor for a predetermined latching period comprises applying a voltage to a terminal of the pass transistor that shuts off the load current.

15. The method of claim 9, further comprising:
testing the current regulating circuit by applying a reference impedance that shorts the load side output for a period of time less than the predetermined current limiting duration; and
measuring a voltage across the reference impedance while the reference impedance is applied to short the load side output.

16. The method of claim 15, further comprising:
receiving a test signal, wherein the reference impedance is applied to short the load side output when the test signal is received.

17. The method of claim 15, further comprising:
determining that the current regulating circuit is functioning correctly when the voltage measured across the reference impedance falls within a predetermined acceptance criteria.

18. A current limiter apparatus having a line side input and a load side output, the apparatus comprising:
a current regulating circuit having a pass transistor that couples the line side input to the load side output, wherein a load current delivered to the load side output flows through the pass transistor, and wherein the current regulating circuit is configured to clamp the load current to a predefined current limit when the load current exceeds a current limiting threshold; and
a latch regulating circuit coupled to the current regulating circuit and the line input side through a semiconductor device having a turn-on voltage threshold higher than the pass transistor, wherein the current regulating circuit provides the latch regulating circuit with a first signal representing a voltage across the pass transistor, and wherein the latch regulating circuit compares the first signal with a second signal from the semiconductor device to determine when the load current exceeds a current limiting threshold;
wherein when the load current exceeds the current limiting threshold for a period of time exceeding a predetermined current limiting duration, the latch regulating circuit outputs a third signal that causes the pass transistor to turn off; and
wherein the latch regulating circuit discontinues the third signal after a predetermined latching period.

19. The apparatus of claim 18, further comprising:
a current limit test circuit coupled to the load side output, the current limit test circuit including a reference impedance and a switching device, wherein the switching device is configured to apply the reference impedance to the load side output.

20. The apparatus of claim 19, further comprising:
a first analog-to-digital converter configured to measure voltage across the reference impedance.
